(19) United States
(12) Patent Application Publication
(10) Pub. No.: US 2021/0377330 A1
(43) Pub. Date: Dec. 2, 2021

(54) LOW-LATENCY VIDEO INTERNET STREAMING FOR MANAGEMENT AND TRANSMISSION OF MULTIPLE DATA STREAMS

(71) Applicant: Radiant Communications Corporation, South Plainfield, NJ (US)

(72) Inventors: Lyubomir Trayanov, South Plainfield, NJ (US); Eugene J. Thaw, Beach Haven, NJ (US)

(21) Appl. No.: 17/287,990

(22) PCT Filed: Oct. 21, 2019
(86) PCT No.: PCT/US2019/057194

§ 371 Date: Apr. 22, 2021

Related U.S. Application Data
(60) Provisional application No. 62/748,861, filed on Oct. 22, 2018.

(51) Int. Cl. H04L 29/06; H04N 21/2187; H04N 21/643

(52) U.S. Cl. CPC H04L 65/608; H04N 21/643; H04N 21/2187; H04L 65/607

(57) ABSTRACT

This disclosure provides a system for low latency, real-time streaming by backhauling multimedia content (e.g., MDU content) via the Internet using Secure Reliable Transport (SRT) connection-oriented protocols, to the data center where the multimedia content is segmented, packaged in MPEG DASH format, and encrypted. The system then publishes the multimedia content via HTTPS to the web that is accessible by users, such as MDU residents.

### CROSS-REFERENCE TO RELATED APPLICATIONS

This application claims priority under 35 U.S.C. § 119(e) to U.S. Provisional Patent Application No. 62/748,861, filed Oct. 22, 2018. The foregoing applications is incorporated by reference herein in its entirety.

### BACKGROUND OF THE INVENTION

With ever-increasing consumer demand for sophisticated communications and entertainment services and the growth of business globalization and networking, network bandwidth requirements have increased at an exponential rate and multiple system operators (MSOs) are forced to look for ways to quickly and cost-efficiently migrate to an architecture that will support the data capacities of today and tomorrow and improve fiber optic transmission networks.

The growth of high-speed internet subscribers, channel offerings, and streaming video services are driving the demand for more bandwidth and speeding up the migration from Hybrid fiber-coaxial (HFC) to Fiber-Deep networks, where the fiber-to-coax conversion point moves closer to the subscriber. This initiative drives the increased demand for fiber patch panel, racks, and cables.

The current build-out of HFC infrastructure includes distribution plants with several RF amplifiers in cascade to boost signals in the feeder and drop networks. The Fiber-Deep solutions are pushing fiber nodes deep into networks so that few or no amplifiers are needed. These optical nodes and no amplifier topologies (e.g., Node Plus Zero Amplifiers) leave only the passive tap and drop network as coax distribution media.

Node Plus Zero raises the proportion of available bandwidth on a per-household basis, cuts plant power consumption, reduces maintenance costs and truck rolls, and provides cable operators the opportunity to become more eco-friendly in their operations. It is also a stepping-stone to an RFoG, Remote PHY, Hybrid PON/RF-PON, EPON/GPON migration of the MSO's networks.

It is estimated that 30 percent of North Americans live in multiple dwelling units, which includes apartment complexes, condo associations, townhouses, mobile home parks, retirement homes, dormitories, etc. The cable operators' share of the MDU market for telecommunication services may be under increasing threat by telephone companies, direct broadcast satellite, and over-the-top (OTT) providers.

Accordingly, there exists a need for a solution to provide low latency video streaming over the Internet. Such a solution allows MDUs to provide high resolution, real-time video content by taking advantage of the existing network infrastructure.

### SUMMARY OF THE INVENTION

This disclosure addresses the need mentioned above in a number of aspects. In one aspect, this disclosure provides a system for providing low latency, real-time multimedia streaming. The system includes a video/audio encoder and a multimedia gateway. The encoder (a) receives from a capture device a video stream comprising video/audio signals and captioning data associated with the video stream (b) segments the video stream into a plurality of multimedia segments; (c) encodes the multimedia segments into a packetized elementary stream; (d) multiplexes the packetized elementary stream into a MPEG-TS stream by a transport-stream (TS) multiplexer; (e) packetizes the multiplexed stream into a plurality of Secure Reliable Transport (SRT) packets; and (f) transmits the SRT packets by an SRT caller over a network.

The multimedia gateway (i) receives by, an SRT listener the SRT packets transmitted from the SRI′ caller of the encoder after establishing a secure connection with the encoder, (ii) restores the SRT packets to MPEG-TS streams, and (iii) re-packages the MPEG-TS streams to dynamic adaptive streaming over HTTP (DASH) multimedia segments, allowing the DASH multimedia segments to be transmitted to a user device whereby the DASH multimedia segments are collected and reconstituted for display on the user device.

In some embodiments, following re-packaging the MPEG-TS streams to the DASH multimedia segments, the system further stores the DASH multimedia segments in a web cache accessible by the user device. In some embodiments, the web cache is hosted on an NGINX web server.

In another aspect, this disclosure also provides a method for providing low latency, real-time multimedia streaming. The method includes: (1) receiving by, a video/audio encoder, from a capture device, a video stream comprising video/audio signals and captioning data associated with the video stream; (2) segmenting the video stream into a plurality of multimedia segments; (3) encoding the multimedia segments into packetized elementary stream; (4) multiplexing the packetized elementary stream into a MPEG-TS stream by a transport-stream (TS) multiplexer, (5) packetizing the multiplexed stream into a plurality of Secure Reliable Transport (SRT) packets and transmitting the SRT packets by an SRT caller over a network; (6) receiving by a multimedia gateway, through an SRT listener, the SRT packets transmitted from the SRT caller of the encoder after establishing a secure connection with the encoder; (7) restoring the SRT packets to MPEG-TS streams; and (8) re-packaging the MPEG-TS streams to dynamic adaptive streaming over HTTP (DASH) multimedia segments, allowing the DASH multimedia segments to be transmitted to a user device whereby the DASH multimedia segments are collected and reconstituted Par display on the user device.

In some embodiments, the method further includes, following re-packaging the MPEG-TS streams to the DASH multimedia segments, storing the DASH multimedia segments in a web cache accessible by the user device.

In some embodiments, the encoder is an H.264/AVC encoder. The encoder can be a single or multichannel broadcast video/audio encoder.

In some embodiments, the MPEG-TS stream has a Group of Pictures (GOP) size of 60 or lower. The MPEG-TS stream may have a GOP size of 12 or lower. In some embodiments, the packetized elementary stream (PES) has a 188-byte packet size.

In some embodiments, the SRT packets are encrypted. The SRT packets may be encrypted by an AES 128-bit standard, an AES 196-bits, or an AES 196-bit standard.

In some embodiments, at least one of the MPEG-TS streams is encoded in a MPEG-2 format. In some embodiments, at least one of the MPEG-TS streams is encoded by an H.264/AVC codec. In some embodiments, an audio portion of at least one of the MPEG-TS streams is encoded by a. Dolby codec.

In some embodiments, at least one of the DASH multimedia segments has a segment size between about 0.5 seconds and about 2 seconds. In some embodiments, the DASH multimedia segments are accessible to the user device via, an HTTP/DASH protocol

In some embodiments, the video stream comprises a live video stream. The video stream may be obtained from the capture device in a multiple dwelling unit (MDU). The capture device can be a surveillance camera or a CCTV camera.

In some embodiments, the user device is selected from the group consisting of a smartphone, a tablet computer, a laptop computer, a desktop computer, a set-top box, a television, a portable media player, a game console, a media server, a stream relay server, a server of a content distribution network (CDN), and a combination thereof.

In some embodiments, the network comprises one of MAN, WAN, LAN, WLANs, internet, intranet, and a combination thereof.

The foregoing summary is not intended to define every aspect of the disclosure, and additional aspects are described in other sections, such as the following detailed description. The entire document is intended to be related as a unified disclosure, and it should be understood that all combinations of features described herein are contemplated, even if the combination of features are not found together in the same sentence, or paragraph, or section of this document. Other features and advantages of the invention will become apparent from the following detailed description. It should be understood, however, that the detailed description and the specific examples, while indicating specific embodiments of the disclosure, are given by way of illustration only, because various changes and modifications within the spirit and scope of the disclosure will become apparent to those skilled in the art from this detailed description.

### BRIEF DESCRIPTION OF THE DRAWINGS

FIG. 1 illustrates an example system for providing low latency, real-time multimedia streaming.

FIG. 2 illustrates an example system for providing low latency, real-time multimedia streaming implemented for CCTV live video streams.

FIG. 3 illustrates an example video/audio encoder.

FIG. 4 illustrates an example multimedia gateway system.

### DETAILED DESCRIPTION OF THE INVENTION

This disclosure provides a system for low latency, real-time streaming by backhauling multimedia content (e.g., MDU content) via the Internet using Secure Reliable Transport (SRT) connection-oriented protocols, to the data center where the multimedia content is segmented, packaged in MPEG DASH format, and encrypted. The system then publishes the multimedia content via HTTPS to the web that is accessible by users, such as MDU residents.

The system features the use of SRT protocols to transport and encrypt multimedia content via the internet to the datacenter and the use of modified Dynamic Adaptive Streaming (SRT) over HTTP/HTTPS (DASH) to stream multimedia content from the data center to a client device, i.e., an MDU client presentation device. The DASH is modified to encapsulate multimedia content in a short segment (e.g., 500-ms to 1-sec segment) for low latency and near real-time presentation at the client device. Embodiments of the system for low latency, real-time streaming are further described below.

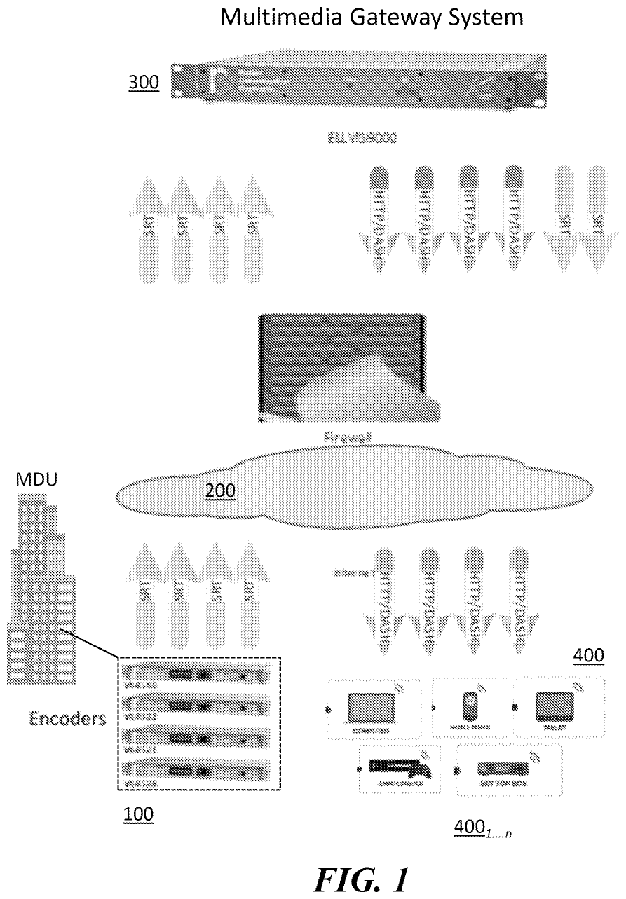

Referring now to FIG. 1, there is illustrated an exemplary process for providing low-latency, real-time multimedia stream content over the internet. At the MDU, one or more video/audio encoders 100 (e.g., VL4500) process video/audio signals into a plurality of video/audio segments. Video/audio segments are then packaged into a plurality of video/audio packets and transported based on the SRT protocols over the internet, by optionally transmitting through firewall 200. Upon the receipt of video/audio packets, multimedia gateway system 300 (e.g., ELLVIS 9000)—also termed multiple stream SRT media gateway—converts the received video/audio packets into video/audio segments based on the DASH protocols (also known as MPEG-DASH). The MPEG-DASH video/audio segments can be stored in a web cache to be accessed by a user device 400, i.e., 400_{1..n}, (e.g., computers, mobile phones, tablets, set-top boxes (STBs), game consoles).

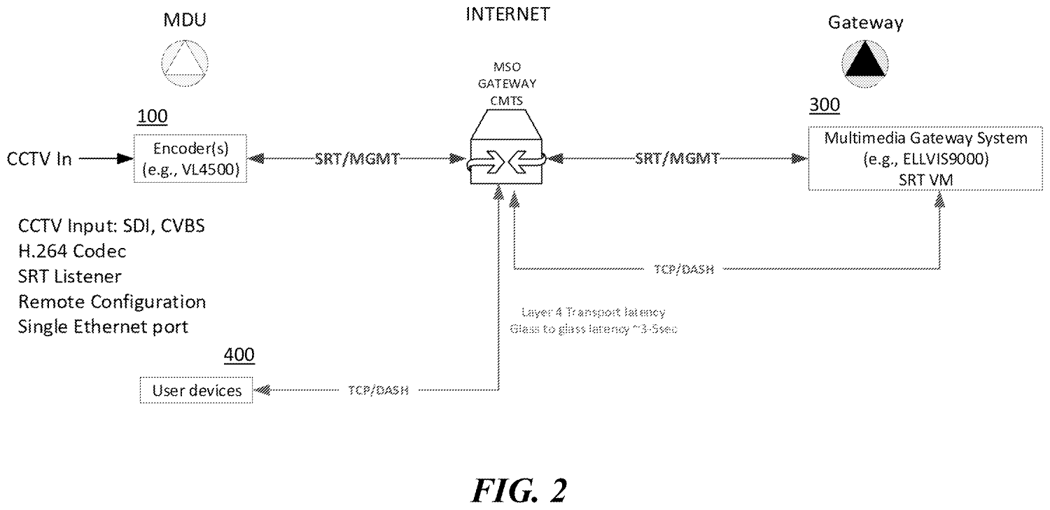

FIG. 2 illustrates a process implemented for providing low-latency, real-time video/audio stream content captured through CCTV cameras over the internet. The embodiments of video/audio encoders 100 and multimedia gateway system 300, as well as the process for providing low-latency, real-time video/audio stream content over the Internet, are described in further detail below.

(a) Video/Audio Encoder

Video/audio encoders, such as VL4500 encoders, can be single or multichannel broadcast video/audio encoders. In some embodiments, the encoder can be H.264/AVC video encoders, having LLC audio, low bitrate with SRT protocol output in caller mode. At the MDU, the encoder encodes video/audio stream content to H.264/AVC formats, which are muxed to MPEG-TS, packaged based on the SRT protocols, encrypted based on AES, and sent over the internet to a remote location of the multimedia gateway system, where they are recovered from internet errors/high RTT/packet loss, etc. Once recovered, the video/audio stream is converted to MPEG TS and sent to the DASH packager, where each stream is further broken down into smaller segments. The packager generates audio and video segments, as well as the presentation file.

As used herein, the term “service,” “content,” “program” and “stream” are used synonymously to refer to a sequence of packetized data that is provided in what a subscriber may perceive as a service. A “service” (or “content,” or “stream”) in the former, specialized sense may correspond to different types of services in the latter, non-technical sense. For example, a “service” in the specialized sense may correspond to, among others, video broadcast, audio-only broadcast, pay-per-view, or video-on-demand. The perceivable content provided on such a “service” may be live, pre-recorded, delimited in time, undelimited in time, or of other descriptions. In some cases, a “service” in the specialized sense may correspond to what a subscriber would perceive as a “channel” in traditional broadcast television.

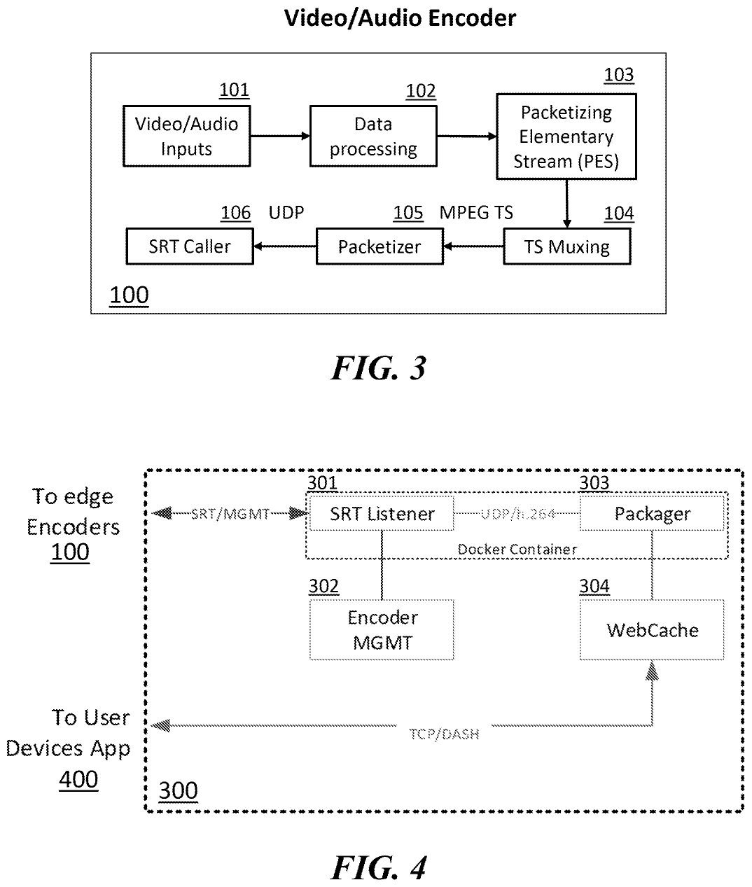

Referring now to FIG. 3, there is illustrated one embodiment of video/audio encoder 100. One or more video/audio encoders 100 (e.g., VL4500) process video/audio signals into a plurality of video/audio segments.

At 101, video/audio signal inputs can be received from one or more capture devices, such as a surveillance camera or an audio recorder, via an HDMI, S-Video, or RCA port. In some embodiments, the encoder may include an analog to digital converter (ADC) to perform analog to digital conversion, when video/audio stream is in the analog format. ADC converts the analog signals such as voltages to digital or binary form consisting of 1s and 0s. Most of the ADCs take a voltage input as 0 to 10V, −5V to +5V, etc. and correspondingly produces digital output as a binary number.

At 102, the digitalized video/audio stream is subject to further processing. The encoder segments the digitalized video/audio stream into a plurality of video/audio segments. In some embodiments, additional information may be appended to individual video/audio segments. For example, a unique identifier, timestamp, or caption information can be added to individual segments if needed. Such information can be appended to the front or the end of a segment data file.

Each video or audio segment can be further encoded using a video or audio codec. A codec is a device or computer program for encoding or decoding a digital data stream or signal. A codec encodes a data stream or a signal for transmission or storage, possibly in encrypted form, and the decoder function reverses the encoding for playback or editing. Codecs are used in videoconferencing, streaming media, and video editing applications.

As used herein, the term “codec” refers to a video, audio, or other data coding and/or decoding algorithm, process or apparatus including, without limitation, those of the MPEG (e.g., MPEG-1, MPEG-2, MPEG-4, etc.), Real (RealVideo, etc.), AC-3 (audio), DivX, XViD/ViDX, Windows Media Video (e.g., WMV 7, 8, or 9), ATI Video codec, AVC/H.264, or VC-1 (SMPTE standard 421M) families. The traditional method of digital encoding or compression is the well-known MPEG-2 format. More advanced codecs include H.264 (also known as MPEG-4) and VC-1. H.264 is a high compression digital video codec standard written by the ITU-T Video Coding Experts Group (VCEG) together with the ISO/IEC Moving Picture Experts Group (MPEG) as the product of a collective partnership effort known as the Joint Video Team (JVT). The ITU-T H.264 standard and the ISO/IEC MPEG-4 Part-10 standard (formally, ISO/IEC 14496-10) are highly similar, and the technology is also known as AVC, for Advanced Video Coding.

In some embodiments, the video/audio segments are encoded in the H.264/AVC format. In some embodiments, for video segments, the encoding/decoding can be carried out by using FPGAs or video CPU core processers. Audio segments can be processed using a DSP codec.

As used herein, the terms “processor,” “microprocessor,” and “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, secure microprocessors, and application-specific integrated circuits (ASICs). Such digital processors may be contained on a single unitary IC die, or distributed across multiple components.

At 103, the encoder packetizes the encoded video/audio segments into a packetized elementary stream (PES) and then multiplexed into a MPEG-TS format. PES is a specification in the MPEG-2 Part 1 (Systems) (ISO/IEC 13818-1) and ITU-T H.222.0 that defines carrying of elementary streams (usually the output of an audio or video encoder) in packets within MPEG program streams and MPEG transport streams. The elementary stream is packetized by encapsulating sequential data bytes from the elementary stream inside PES packet headers. Typically, transmitting elementary stream data from a video or audio encoder is to first create PES packets from the elementary stream data and then to encapsulate these PES packets inside Transport Stream (TS) packets or Program Stream (PS) packets. The TS packets can then be multiplexed and transmitted using broadcasting techniques, such as those used in an ATSC and DVB. Transport Streams and Program Streams are each logically constructed from PES packets. PES packets shall be used to convert between Transport Streams and Program Streams. In some cases the PES packets need not be modified when performing such conversions. PES packets may be much larger than the size of a Transport Stream (TS) packet.

MPEG, such as the MPEG-2 standard protocol, defines the protocol that can be used to encode, multiplex, transmit and de-multiplex and decode video, audio, and data bitstreams. Video compression is an important part of the MPEG standards. Additionally, MPEG-2 includes a family of standards involving different aspects of digital video and audio transmission and representation. The general MPEG-2 standard is currently divided into eight parts, including systems, video, audio, compliance, software simulation, digital storage media, real-time interface for system decoders, and DSM reference script format. The video portion of the MPEG-2 standard (IS O/IEC 13818-2) sets forth the manner in which pictures and frames are defined, how video data is compressed, various syntax elements, the video decoding process, and other information related to the format of a coded video bitstream. The audio portion of the MPEG-2 standard (ISO/IEC 13818-3) similarly describes the audio compression and coding techniques utilized in MPEG-2. The video and audio portions of the MPEG-2 standard, therefore, define the protocol with which audio or video information is represented.

At some point, the video, audio, and other digital information must be multiplexed together to provide encoded bitstreams for delivery to the target destination. The systems portion of the MPEG-2 standard (ISO/IEC 13818-1) defines how these bitstreams are synchronized and multiplexed together. It does not specify the encoding method. Instead, it defines only the resulting bitstream. Typically, video and audio data are encoded at respective video and audio encoders, and the resulting encoded video and audio data are input to a MPEG-2 Systems encoder/multiplexer. This Systems multiplexer can also receive other inputs, including control and management information such as authorization identifiers, private data bitstreams, and time stamp information. The resulting coded, multiplexed signal is referred to as the MPEG-2 transport stream. Generally, a data transport stream is also the format in which digital information is delivered via a network to a receiver for display.

The video and audio encoders provide encoded information to the Systems multiplexer in the form of an “elementary stream.” These elementary streams are “packetized” into packetized elementary streams which are comprised of many packets. Each packet includes a packet payload corresponding to the content data to be sent within the packet, and a packet header that includes information relating to the type, size, and other characteristics of the packet payload.

Elementary stream packets from the video and audio encoders are mapped into transport stream packets at the systems encoder/multiplexer. The transport packets differ from the elementary stream packets in that transport stream packets are a uniform size, e.g., 188 bytes. Each transport stream packet includes a payload portion that corresponds to a portion of the elementary packet stream and further includes a transport stream packet header. The transport stream packet header provides information used to transport and deliver the information stream, as compared to the elementary stream packet headers that contain information directly related to the elementary stream.

At 105, the multiplexed packets in the MPEG-TS format are further processed and packetized for transporting over the internet at 106, based on the SRT protocols. In some embodiments, the packets may be encrypted, for example, based on the AES standard (e.g., AES 128, 196, or 256 bits). SRT is a video transport protocol that optimizes streaming performance across unpredictable networks, such as the internet, by dynamically adapting to the real-time network conditions between transport endpoints. SRT takes some of the best aspects of User Datagram Protocol (UDP), such as low latency, but adds error-checking to match the reliability of Transmission Control Protocol/Internet Protocol (TCP/IP). While TCP/IP handles all data profiles and is optimal for its job, SRT can address high-performance video specifically. Thus, SRT has the combined advantages of the reliability of TCP/IP delivery and the speed of UDP. This helps minimize effects of jitter and bandwidth changes, while error-correction mechanisms help minimize packet loss. SRT supports end-to-end encryption with AES (e.g., AES 128/256-bit encryption) and simplified firewall traversal. When performing retransmissions, SRT only attempts to retransmit packets for a limited amount of time, based on the latency as configured by the application. Because SRT ensures security and reliability, the public internet is now viable for an expanded range of streaming applications—like streaming to socialcast cloud sites (e.g., LiveScale omnicast multi-cloud platform's concurrent distribution to multiple social media such as Facebook Live, YouTube, Twitch and Periscope from one live video feed), streaming or remoting an entire video wall content, or regions of interest of a video wall, and the like.

As used herein, the terms “Internet” and “internet” are used interchangeably to refer to inter-networks including, without limitation, the Internet. As used herein, the terms “network” and “bearer network” refer generally to any type of telecommunications or data network including, without limitation, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.). As used herein, the terms “network agent” and “network entity” refers to any network entity (whether software, firmware, and/or hardware-based) adapted to perform one or more specific purposes. For example, a network agent or entity may comprise a computer program running in server belonging to a network operator, which is in communication with one or more processes on a CPE or other device.

As used herein, the term “network interface” refers to any signal, data, or software interface with a component, network or process including, without limitation, those of the Firewire FW400, FW800, etc.), USB (e.g., USB2), Ethernet (e.g., 10/100, 10/100/1000 (Gigabit Ethernet), 10-Gig-E, etc.), MoCA, Serial ATA (e.g., SATA, e-SATA, SATAII), Ultra-ATA/DMA, Coaxsys (e.g., TVnet™) radiofrequency tuner (e.g., in-band or OOB, cable modem, etc.), WiFi (802.11a,b,g,n), WiMAX (802.16), PAN (802.15), or IrDA families.

As used herein, the term “WiFi” refers to, without limitation, any of the variants of IEEE-Std. 802.11 or related standards including 802.11 a/b/g/n. As used herein, the term “wireless” means any wireless signal, data, communication, or other interface including without limitation WiFi, Bluetooth, 3G, 4G, HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter-wave or microwave systems, acoustic, and infrared (i.e., IrDA).

As disclosed herein, the SD/HD MPEG2 and AVC encoders, such as VL4500 encoders, allow the MSO to replace the legacy analog audio and video fiber transmitters with cost effective HD capable multi-channel encoder. As used herein, the terms “MSO” or “multiple systems operator” refer to a cable, satellite, or terrestrial network provider having infrastructure required to deliver services including programming and data over those mediums.

That transport eliminates fiber receiver, encoder, and groomer from the headend, thus significantly reducing rack space, power consumption and heat dissipation. The encoder allows the encoding and transporting over GigE multiple CableLabs compliant streams, providing a solution for most of the PEG and local insertion channel loading scenarios.

The SD/HD MPEG2 and AVC encoders feature closed caption support, AFD, logo overlay, PiP mode, Ad insertion points, EAS Static image insertion, and VLAN support. These features may be placed in the encoder unit in an MSO's video environment. The encoder using, for example, VL4500 Series SRT video transport protocol enables the delivery of high-quality and secure, low-latency video across the public internet, reducing equipment and transport/service cost.

The SD/HD MPEG2 AND AVC encoder, such as VL4500, features the following characteristics: up to eight channels of MPEG-2 or H.264 AVC programs, ASI, IP, QAM and RFoG outputs, EIA708 and EIA608 closed captions, AFD with auto-resize option, logo overlay, broadcast delivery over public Internet with SRT protocol, down/up-conversion option and deinterlacer, picture in picture option, EAS/local alert static image encoding, Ad insertion points option, intuitive web-based GUI, VividEdgeIoT predictive maintenance package add-on.

With compression efficiency and advanced pre-processing, the encoder delivers both HD and SD content at low bitrates and uncompromised quality. As a result, the encoder, such as the VL4500 Series, can be used to deliver video services across all networks and fulfill multiple applications for various business models.

The encoders provide cost-effective live streaming of PEG and in-house channels. With SD/HD simulcast function, the encoder allows the broadcaster to stream both SD and HD content from one source by utilizing the video scaling and conversion functions while utilizing low power consumption and minimal heat output. The SFP output interface allows the operator to use either existing duplex or single fiber or 1000B RJ45.

The encoder can be controlled and managed with either the out-of-band network port located on the front panel or via the RS232 serial port. In-band management through the TS port is possible, as well. In some embodiments, the system also provides a web management system that is through both TS and MGMT Ethernet interfaces. The web management system provides user interface to allow users to set or modify settings for the encoders. Examples of settings include, without limitation, video settings, audio settings, TS settings, network settings, system settings, and user presets. Changed settings will take effect only after the encoder is started or restarted via the buttons on the bottom of the screen. Settings can be saved to a desired preset; preset includes also the current state of the encoder. Typically, the encoder is being shipped with encoder factory preset. Saving on that preset is not possible. After the unit is configured, a new preset should be created and saved.

As used herein, the term “user interface” refers to, without limitation, any visual, graphical, tactile, audible, sensory, or other means of providing information to and/or receiving information from a user or other entity, such as a GUI.

Under the Video Settings tab, the user can set specific codec parameters and SDI Video Input signal information, which includes Input resolution and frame rate. Supported resolutions include without limitation 1080p at 24, 29.97, 30 and 59.94 fps (H.264, 1×3G mode only), 1080i at 24, 29.97 and 30 fps, 720p at 29.97, 30, 50, 59.94 and 60 fps, and 480i at 29.97 and 30 fps. The detected resolution and frame rate are shown on the web page under video Input. The output resolution follows the input resolution of the incoming SDI signal, or it could be forced. In case that the output resolution is forced the input, signal must have the same resolution as the input. The disclosed encoder

The encoder can support either SDI or composite video input. The selection of the active video input can be done from the dropdown menu of Input Source parameter. Save the new video input source prior to restarting or starting the unit. For multichannel versions of the unit the selections of active SDI video inputs and audio inputs for an encoder instance must match.

Encoding field order can be selected to either TFF (top field first) or BFF (bottom field first). When down-converting from HD to SD with QBA support for old legacy STB, set the filed order to TFF for the SD encoder. H264 encoding is supported only in BFF field order.

The encoder supports the bitrate ranges, including without limitation MPEG2 HD resolution Range from 7M to 25M, MPEG2 SD resolution Range from 1M to 15M, H264 HD resolution Range from 2M to 25M, and H264 SD resolution Range from 500 k to 25M.

The user can select the aspect ratio, scaling mode for HD to SD down-conversion, and rate control for the encoder. The supported video ratios are 16:9 (widescreen) and 4:3 (normal). Both CBR (constant bit rate) and VBR (variable bit rate) encoding are supported.

Under the VBR rate control, the encoder will vary the number of bits used to represent a frame so that the overall average amount of bits-per-frame is achieved. It does this by taking bits from frames with less information to encode (that does not need them) and giving them to frames that have more information to encode (and does need them). With CBR each frame uses the same number of bits regardless of whether it needs them or not.

The MPEG2 or H.264 video needs a suitable GOP structure. GOP stands for ‘Group of Pictures’ and refers to the sequence of frames in the stream. When the video is encoded, the compression algorithm puts the video content into different types of frames, usually just I-frames, P-frames, and B-frames. The I-frames are almost complete and can be played without any further information. They do not rely on other frames for their interpretation or playing. On the other hand, P-frames contain only the details that describe the differences between that frame and the previous frame—they are forward “Predicted.” A B-frame (Bi-predictive picture), on the other hand, contains only the differences between the current frame and both the preceding and following frames and, as a result, allows more compression.

A GOP consists of an initial I-frame and a sequence of P and B frames. The GOP length is the number of frames in each repeated sequence (one I-frame in each), and it is being set via the I-Frame interval. A typical GOP with structure IBBP and I-Frame interval of 15.

Standard practice is to use GOP with an I-Frame interval, which is half of the input video frame rate for MPEG2 and full for H.264. B-frames improve the quality of the picture, but they also increase the latency by 1 frame time. To minimize latency, B-frames should be lowered or disabled. Recommended encoding GOP for MPEG2 is IBBP, which has 2 B frames, and for MPEG4/H.264 is IBBBP, which has 3 B frames.

A problem that occurs while using MPEG compression is error propagation. It is obvious that when there is an error in the I-frame and the following frames are calculated with this frame, the error will continue in these frames as well. This is one of the reasons the GOP structure is repeated. It ensures a new I-frame to rebuild a perfect image, although the arrival of the I-frame might take some time.

For fast motion video that needs to be encoded at a lower bitrate, it is recommended that the GOP size be set to 12 or lower. For slow to moderate motion or digital signage video the GOP size should set to half of incoming video frame rate.

The encoder provides a dual-stream output, one in HD resolution and a second down-converted to SD resolution. If 1×HD+1×SD mode is selected in the Settings tab the bitrate resolution and GOP structure needs to be set as shown below. The typical bitrate for MPEG2 SD service is 3000 to 3500 k and for MPEG4/H.264 1000 to 1500 k. The available resolutions are 480i or 480p. The encoder supports MPEG4/H.264 progressive and field-based interlaced coding with ARF (Adaptive Reference Field), SPF (Same Parity Reference Field) and MBAFF (Macroblock-Adaptive Frame/Field Coding) control modes.

H.264 AVC codec supports three modes MBAFF, ARF, and SPF. MBAFF mode, that mode will significantly improve the video quality for a given bitrate. The MBAFF or Macroblock-Adaptive Frame/Field Coding is a video encoding feature of MPEG-4 that allows a single frame to be encoded partly progressive and partly interlaced. MBAFF allows the encoder to examine each block in a frame to look for similarities between interlaced fields. When there is no motion the fields will tend to be very similar, resulting in better quality if the block is to be encoded as progressive video. For blocks where there is a motion from one field to another, the quality is more likely to suffer if encoded progressive, so these blocks can remain interlaced. For HD video bitrates below 4.5M, it is suggested to set the GOP in that mode to up to 4 B-frames and 30 I-Frame intervals. For bitrate above 4.5M, the I-frame interval could be increased to 240.

ARF mode is more suited to mix content with active motion and static images, it will show more static image artifact. However, it features faster encoding and processing. The GOP can be set to up to 4 B frames and 240 I frame interval. HD Bitrates below 3.2M are not suggested in that mode. SPF mode will be used for sports content at high bit rates, at low bitrate the mode shows high number of artifacts. The bitrate in that mode can go to as low as 2M for HD with up to 4 B-frames and 240 I-frame intervals.

Being a relatively new technology, MBAFF is still not supported well among legacy AVC hardware and software decoders. While not as efficient as the newer MBAFF, in terms of bandwidth vs quality, SPF and ARF modes perform in faster encoding and are supported by legacy AVC hardware and software decoders.

HRD buffer Setting for H.264. To manually calculate max HRD Buffer use: (17178750*8)/video bitrate (bps). For H.264 I-frame Interval must be multiple of (number of B frames+1). For example, 2×B-frames, I-frame interval can be 30. With 3×B-frames, I-frame interval can be 32.

The disclosed encoders, including VL4500 units, support CEA608 and CEA708 closed captions. Firmware version 3.00.056 adds support for, i.e., 608CC on VBI line 21, 608-ANC CC, 608 captions on the ancillary data, CC608 5334—Extracts the closed caption data from the Ancillary data packet SMPTE 334M (Data Identifier DID0x61 Secondary Data Identifier SDID 0x02), 608 CDP—Extract the 608 closed captions that are embedded in the CEA 708 Ancillary data stream of SMPTE 334M (DID 0x61 SDID 0x01).

There are four modes when closed captions are enabled: Default—encoder captures and generates 708CC data for HD streams and 608CC data for SD; CEA 608—forces 608CC data to the stream; CEA 708—forces 708CC data to the stream; and Input—pass through the CC data from the video input.

AFD enable menu, allows the selection of: Bypass—passes thought AFD value captured from SDI input to MPEG video stream; Auto Resize—automatically adjust scaling for HD down convert channels (HD to 480i) based on AFD value in the SDI input; and User data—Inserts AFD codes 1 to 15 (0000-1111).

The Audio Settings tab allows the setting of the audio input, codec, bitrate, audio gain (−20 dB to +20 dB), Dialnorm (AC3 only) and channel mode. For multichannel versions of the unit the selections of active SDI video inputs and audio inputs for an encoder instance must match. The encoder supports AC3 2.0, MPEG Layer II and AAC audio codecs. The channel mode can be set to Mono or Stereo. The Mono mode actually supports a dual-channel, allowing the encoding of two separate audio channels (SAP). The available audio bitrates are 96, 128, 192 and 384 k.

Additionally, the encoder also supports the modes for CATV applications, including Audio Codec: AC3, Audio Bitrate: 192 k, and Channel: Mono/Stereo.

Regarding TS settings, transport stream (TS) is a format that allows multiplexing of digital video and audio and synchronizes the output. The TS consists of single (SPTS) or multiple (MPTS) programs. The programs are defined by groups of one or more PIDs that are related to each other. For instance, a transport stream used in digital television might contain three programs to represent three television channels. Suppose each channel consists of one video stream, one or two audio streams, and any necessary metadata. A receiver wishing to tune to a particular “channel” merely has to decode the payload of the PIDs associated with its program. It can discard the contents of all other PIDs.

The program is identified by Program or Service ID, the video elementary stream by the Video PID and audio elementary stream by an Audio PID. Program Map Tables, or PMTs, contain information about programs. For each program, there is a PMT, with the PMT for each program appearing on its own PID. The PMTs describe which PIDs contain data relevant to the program. PMTs also provide metadata about the streams in their constituent PIDs. For example, if a program contains a MPEG-2 video stream, the PMT will list this PID, describe it as a video stream, and provide the type of video that it contains. To assist the decoder in presenting programs on time, at the right speed, and with synchronization, programs usually periodically provide a Program Clock Reference, or PCR, on one of the PIDs in the program. PAT stands for Program Association Table. The PAT lists PIDs for all PMTs in the stream. The TS settings tab also allows the setup for Transport stream identifiers.

The encoder supports both Unicast and Multicast IP delivery with user-adjustable TTL. A Unicast transmission/stream sends IP packets to a single recipient on a network. A Multicast transmission sends IP packets to a group of hosts on a network. If the streaming video is to be distributed to a single destination, then the destination IP address and port on the encoder must equal to the receiving decoder IP address and port. If the application requires the decoding of the stream at multiple concurrent locations, then the destination IP address and port must be set to a valid Multicast IP address in the range of 224.0.0.0 to 239.255.255.255.

Multicasting is not supported on some legacy network devices. Before using the encoder in the Multicast streaming mode, check the functional specifications of the network infrastructure to ensure that the Multicast stream will not create major traffic on the network. Verify that the backbone switch supports Internet Group Messaging Protocol (IGMP) snooping, which allows the core of the network to ignore the traffic streams that Multicasting may generate.

The TS rate for CATV installations must have a constant bit rate (CBR), for transport over the internet or point to point applications, transport stream bit rate control could be set to variable bit rate (VBR).

SRT protocol is a transport technology that optimizes streaming performance across unpredictable networks like the internet with secure streams and easy firewall traversal, bringing the best quality live video over the worst networks. It accounts for packet loss, jitter, and fluctuating bandwidth, maintaining the integrity and quality of the video. Internet streaming obstacles include packet Loss—packets being discarded by routers; jitter—packets arriving at different times than expected and sometimes out of order; latency—time from sender to receiver; and bandwidth—the fluctuating capacity between points.

The SRT protocol relies on bi-directional UDP traffic to optimize video streaming over public networks. In addition to the video data that is sent in one direction—from a content source device (such as a VL4500 Encoder) to a Destination (such as a VL4500 SRT Gateway)—there is a constant exchange of control information between the two endpoints, including “keep-alive” packets approximately every 10 ms, which allow SRT streams to be automatically restored after a connection loss.

SRT modes include without limitation Caller mode which sets a source device as the initiator of an SRT streaming session. The caller device must know the public IP address and port number of the Listener; and Rendezvous mode allows two devices behind firewalls to negotiate an SRT session over a mutually agreed upon the port. Both source and destination must be in Rendezvous mode.

Destination IP Address is the target address for the SRT stream, which is the IP address of, for example, the SRT Gateway.

Adaptive bitrate setting will allow the encoder to dynamically adjusts the video bitrate when available bandwidth fluctuates. Changes in the network bandwidth are detected by the SRT protocol and relayed to the encoder. If the bandwidth drops below levels that can support the set output bandwidth, the bitrate is reduced to levels that will assure the best video is transmitted. If the SRT protocol detects that bandwidth capacity is restored, the encoding engine will increase the video bitrate to maximize video quality. The bitrate variations are in the range Set Bitrate to 2M for HD video and down to 500 k for SD video.

The UDP source port for the SRT stream, which is the unique port over which the encoder will be sending the SRT stream. Optionally, the UDP source port can be specified. If not filled in, an ephemeral source port will be assigned (between 32768 and 61000). Destination Port is the port over which the VL4500 SRT Gateway will be listening.

SRT streams can be encrypted using AES cryptographic algorithms and decrypted at their destination. To implement encryption on an SRT stream, the type of encryption must be specified on the source device, and then a passphrase on both source and destination. Encryption can be set to AES-128, 196, or 256 modes. Passphrase specifies a string used to generate the AES encryption key wrapper via a one-way function such that the encryption key wrapper used cannot be guessed from knowledge of the password.

Along with the standard parameters associated with any streaming output, there are other important values to be specified for an SRT stream. An SRT stream can be sent over a channel of some kind, such as a LAN or Internet connection, with a certain capacity. Packets being sent from a source are stored at the destination in a buffer. At some point, there is a total link failure, and then, shortly after, the connection is re-established. So, for a short period of time, the destination is receiving no data. SRT deals with such situations in two ways. The first is that the destination relies on its buffer to maintain the stream output at its end. The size of this buffer is determined by the SRT Latency setting. Once the link is re-established, the source is able to resume sending packets, including re-sending the packets lost during the link failure. To handle this extra “burst” of packets, an SRT stream allows for a certain amount of overhead. This bandwidth overhead is calculated such that, in a worst-case scenario, the source can deliver the number of packets “lost” during the link failure over a “burst time,” where “burst time” must be equal to packets “lost” during the link failure. The maximum time period for which a burst of lost packets can be sustained without causing an artifact is:

SRT Latency (ms)*Bandwidth Overhead (%)=100

Round Trip Time (RTT) is the time it takes for a packet to travel from a source to a destination and back again. It provides an indication of the distance (indirectly, the number of hops) between endpoints on a network. Between two SRT devices on the same fast switch on a LAN, the RTT should be almost 0. Within the Continental US, RTT over the Internet can vary depending on the link and distance, but can be in a 60 to 100 ms range. Transoceanic RTT can be 60-200 ms depending on the route. RTT is used as a guide when configuring Bandwidth Overhead and Latency. To find the RTT between two devices, the ping command can be used.

RTT Multiplier is a value used in the calculation of SRT Latency. It reflects the relationship between the degree of congestion on a network and the Round Trip Time. As network congestion increases, the rate of exchange of SRT control packets (as well as retransmission of lost packets) also increases. Each of these exchanges is limited by the RTT for that channel, and so to compensate, SRT Latency must be increased. The factor that determines this increase is the RTT Multiplier, such that:

SRT Latency=RTT Multiplier*RTT

The RTT Multiplier, then, is an indication of the maximum number of times SRT will try to resend a packet before giving up. Packet Loss Rate is a measure of network congestion, expressed as a percentage of packets lost with respect to packets sent. Constant loss refers to the condition where a channel is losing packets at a constant rate. In such cases, the SRT overhead is lower bound limited, such that:

Minimum Bandwidth Overhead=1.65*Packet Loss Rate

Burst loss refers to the condition where a channel is losing multiple consecutive packets, up to the equivalent of the contents of the SRT latency buffer. In such cases, the SRT overhead is lower bound limited, such that:

Minimum Bandwidth Overhead=100+RTT Multiplier

Burst losses that last longer than the SRT Latency will result in stream artifacts. SRT Latency should always be set to a value above the worst-case burst loss period.

The control packets associated with an SRT stream do, of course, take up some of the available bandwidth, as do any media packet retransmissions. When configuring an SRT stream, a Bandwidth Overhead value will need to be specified to allow for this important factor. The portion of audio and video content in the stream is determined by their respective bit rate settings, which are configured on the audio and video encoders themselves. SRT Bandwidth Overhead is calculated as a percentage of the A/V bit rate, such that the sum of the two represents a threshold bit rate, which is the maximum bandwidth the SRT stream is expected to use.

The SRT Bandwidth Overhead is a percentage assigned, based in part on the quality of the network over which will be streaming Noisier networks will require exchanging more control packets, as well as resending media packets, and, therefore a higher percentage value. SRT Bandwidth Overhead should not exceed 50%. The default value is 25%.

When streaming video at a bit rate of 1000 kbps and audio at 128 kbps, it gives a total of 1128 kbps, which rounds up to 1200 kbps to account for any metadata and other ancillary data. This is the Average Bandwidth, which is calculated automatically based on the actual output settings. If the default Bandwidth Overhead setting of 25% is accepted, then the total bandwidth reserved for the SRT stream will be:

1200+(25%*1200)=1500 kbps (1.5 Mbps)

This is the maximum bandwidth SRT will use. If there is no loss, only a slight overhead for control is used. As long as this total SRT bandwidth is less than or equal to the bandwidth available between the SRT source and destination devices, the stream should flow from one to the other without incident.

Latency is a time delay associated with sending packets over a (usually unpredictable) network. Because of this delay, an SRT source device has to queue up the packets it sends in a buffer to make sure they are available for transmission and re-transmission. At the other end, an SRT destination device has to maintain its own buffer to store the incoming packets (which may come in any order) to make sure it has the right packets in the right sequence for decoding and playback. SRT Latency is a fixed value (from 20 to 8000 ms) representing the maximum buffer size available for managing SRT packets.

An SRT source device's buffers contain unacknowledged stream packets (those whose reception has not been confirmed by the destination device). An SRT destination device's buffers contain stream p The SRT Latency should be set so that the contents of the source device buffer (measured in msecs) remain, on average, below that value, while ensuring that the destination device buffer never gets close to zero.

The value used for SRT Latency is based on the characteristics of the current link. On a fairly good network (0.1-0.2% loss), a “rule of thumb” for this value would be four times the RTT. In general, the formula for calculating Latency is:

SRT Latency=RTT Multiplier*RTT

SRT Latency can be set on both the SRT source and destination devices. The higher of the two values are used for the SRT stream.ackets that have been received and are waiting to be decoded.

The encoder, such as VividEdge VL4510D, encoder supports single profile MPEG-DASH streaming. For proper operation, the encoder must be set in H.264 video encoding, LLC audio encoding, 1×3G video mode and TCP output mode. In addition to the above TS ethernet port must have access to NTP server for the encoder time sync.

The HTTP streaming option has a couple of key parameters: Segment Size—specifies the short interval of playback time of the content; Presentation delay—Specifies a delay, in seconds, to be added to the media presentation time. This affects the delay between the calculated live edge and the one in use. A lower value will make play closer to the real live edge, but there will be more stalls if the network conditions worsen; Min Buffer time—This allows faster recovery from stalls by allowing one to start playing with less content, at the cost of a higher chance of another stall. That value is most likely overwritten by the player buffering and rebuffering values; Min update period—Indicates to the player how often to refresh the media presentation description in seconds; and Time Shift Buffer Depth—specifies the duration of pas content kept available outside of the live edge

Segment size for the stream can be set the TS settings tab of the management page.

Under auto mode, the only parameter that is set by the user is the segment size. The rest are calculated automatically by the following: Time Shift Buffer=4*Segment size+6; Presentation delay=2*segment size; Min Buffer time=segment size; and Min update period=5 sec.

The encoder GOP size can be configured in a way that every segment has at least one reference I-frame. For example, for segment size of 1s the I-frame interval should be set to 60 or less, for 2s segment I-frame interval should 120 or less.

The user interface also provides a Network Settings tab that is used to set the network configuration and address for the Management and TS Ethernet ports. The user can add a VLAN ID on each port.

By enabling VLAN and disabling the Out of Band Management port VLAN can be set on the TS Port, allowing to send both Management and TS network on two different IDs over SFP TS port. VLAN can be enabled on the Setting page as shown below. In cases where either one or both Ethernet ports of the encoder are being connected to public network/internet place the device behind hardware firewall in order to protect the encoder from malicious interference, or at minimum disable the telnet port from the System setup tab. Other options include enable/disable terminal access via telnet or ssh, typically reserved for support and factory needs. In that mode the encoder will send log entries to a remote sys-log server.

An example of the disclosed encoders are characterized by one or more of the following specifications:

SDI INPUT

SMPTE 259M(SD-SDI)/292M(HD-SDI)/424M(3G), BNC, 75 Ohm

VIDEO AND AUDIO

MPEG-2 MP@ML 1-15 Mbps

MPEG-2 MP@HL 2-24 Mbps

H.264 AVC MP@L3.0 0.5-8 Mbps

H.264 AVC MP@L4.2 2-24 Mbps

MPEG-2 GOP 10-60 FRAMES, IBBP

H.264 AVC GOP 10-240 FRAMES, IBBBBP

RESOLUTIONS: 480i, 720p, 1080i and 1080p

PiP: 96, 128, 192 and 3521

FRAMERATES: 24, 25, 29.97, 30, 59.94 and 60 fps

CHROMA: 4:2:0

AUDIO CODEC: Dolby Digital 2.0, MPEG Layer2, AAC

SAMPLING RATE: 48 kHz

BITRATE: 93-384 kbps

COMPOSITE VIDEO/AUDIO

NTSC, BNC, 75 Ohm 10K

UNBALANCED STEREO AUDIO, 6-PIN CONNECTOR

TS OUTPUT

ISO/IEC 13818 SPTS/MPTS MPEG TS, 1000BaseT or SFP GigE, Public

network/Internet SRT Streaming Protocol

QAM OUTPUT

QAM 64/256 Annex B, 54 Mhz-1 GHz, MER <40, 55 dBmV

RFoG OUTPUT

DWDM ITU (ch18 to ch64) Laser, 7 mW, 11% OMI CEA 608 from Line 21,

CEA 708 per

SMPTE 334M, AFD, SCTE104

VIDEO PROCESSING

Down-Conversion with Letterbox, Anamorphic and center cut

AFD bypass, user input, and auto resize

Resolution and framerate conversion

DPI Trigger Insertion via SCTE35 and SCTE1041

Logo Overlay1

EAS/Local Alert Static image encoding on all channels

VIDEO AND AUDIO

SMPTE 259M(SD-SDI)/292M(HD-SDI)/424M(3G), BNC, 75 Ohm MPEG-2

MP@ML 1-15 Mbps

MPEG-2 MP@HL 2-24 Mbps

H.264 AVC MP@L3.0 0.5-8 Mbps

H.264 AVC MP@L4.2 2-24 Mbps

MPEG-2 GOP 10-60 FRAMES, IBBP

H.264 AVC GOP 10-240 FRAMES, IBBBBP

RESOLUTIONS: 480i, 720p, 1080i and 1080p

PiP: 96, 128, 192 and 3521

FRAMERATES: 24, 25, 29.97, 30, 59.94 and 60 fps

CHROMA: 4:2:0

AUDIO CODEC: Dolby Digital 2.0, MPEG Layer2, AAC

SAMPLING RATE: 48 kHz

BITRATE: 93-384 kbps

ANCILLARY DATA

CEA 608 from Line 21, CEA 708 per SMPTE 334M, AFD, SCTE104

ENVIRONMENTAL AND POWER

Power 35 W @ 90 to 240 VAC (DC Power Brick)

Weight 51b

Operational Temp 0° to 50° C.

Storage Temp −10° to 60° C.

Dimensions 1RU 17.0″ W×9.0″D×1.75″ H

(b) Multimedia Gateway System

The multimedia gateway system is one of the main components of the disclosed multimedia streaming system. It receives multiple SRT streams from edge encoders at MDUs, reformats the streams back to the MPEG TS format, and sends them to DASH packager for slicing to small audio and video segments. The content then is sent to web cache to allow 200 or more simultaneous connections to each DASH package.

Each SRT listener and DASH packager reside in their own dynamically generated docker container. That allows the system to be scalable to up to 100 streams (e.g., 20, 40, 80)/MDU's per system. The web cache and management system will reside on the host servers. A separate module could be added to each container for remote management of the edge encoders.

The disclosed multiple stream SRT media gateway, such as ELLVIS9000, supports

Dynamic Adaptive Streaming over HTTP (DASH) and OTT Web Hosting. Dynamic stream type and short segment size (0.5 to 1 seconds) are ideal for live video applications where low stream latency is critical. Web hosting may be over HTTP or HTTPS for added security. Up to 40 instances of packager and web host may be loaded into the 1 RU footprint. This is an ideal solution for MDU/Institutional local video content hosting where the physical network architecture is IP centric.

The multimedia gateway system, such as ELLVIS9000 SRT Gateway, is an integrated bidirectional SRT/UDP Transport Appliance. When used with the disclosed encoders, for example, VividEdge SRT-ready MPEG Video Encoders, the system allows delivery of multiple streams of high-quality secure and low-latency video across the public internet.

This innovative solution enables MPEG2 and H.264 broadcast-quality streams to be transported from any venue despite unreliable Internet connections. It eliminates the need for Satellite/Microwave/Leased Line connections, providing high-quality cost-effective transport for PEG and broadcast feeds. It also features the following characteristics: broadcast delivery over public Internet, low latency, Protection from packet loss, bandwidth fluctuatons, jitter, and delay, end-to-end AES encryption, error recovery, firewall-friendly, one to many fanout capabilities, integrated DASH packager/web host, one time buy for stream counts, upgradeable, no separate server required (virtualized models), no recurring bandwidth service charge, single-vendor solution, intuitive web-based GUI, login security, SRT caller/listener/rendezvous modes, live OTT streaming video applications, compatible with SRT enabled MPEG encoders.

The DASH is implemented together with SRT protocol inside of docker containers, some of the DASH packager setup scripts were changed by modifying the standard manner to generate different segment sizes, buffering levels, and presentation delays. Both of those implementations lead to a very low latency of ingesting stream from public internet and slicing it to segments.

The content stream transmitted through the system can be encrypted. The encryption is handled within the SRT protocol, SRT supports AES up to 256-bit encryption. For example, VL4500 SRT caller may encrypt the stream and ELLVIS9000 listener module may decrypt it.

The incoming video and audio signals are encoded with H.264 video codec running on embedded hardware-accelerated m3 processors and audio LLC codec on DSP. The video and audio elementary streams (ES) are then muxed into MPEG TS and send on the IP output with SRT protocol. The SRT protocol allows the video signals to be send encrypted (via AES encryption) over a public network like the internet with extremely low latency. On the listener side, the multimedia gateway system is running an embedded Linux system with docker containers. On the fly a new docker container can be created that has SRT listener devices that recover the “noisy” internet signal and regenerates the MPEG TS sent from the encoder. Inside the container, there is a DASH packager with modified scripts to achieve a lower latency of the video and audio stream. The docker implementation of SRT+DASH creates completely independent from each other and from the system streams which makes the system highly scalable. The output of each container is sent to a web cache system that serves the segments to the remote players and also authenticates the traffic.

Referring now to FIG. 4, there is illustrated an example multimedia gateway system (e.g., ELLVIS 9000). The multimedia gateway system can be implemented based on Linux (e.g., Ubuntu) or Windows platforms.

As an initial step, the SRT listener 301 establishes a connection with one or more SRT callers 106 of the encoders, e.g., VL4500. Typically, the multimedia gateway system employs static IPs, whereas the encoder employes dynamic IP addresses. Dynamic IP modem is considered residential service, which is much cheaper than that with static IP address, because cable modems with static IP addresses are considered as business class servers. By using dynamic IP address for the encoder, it helps to lower monthly subscription fees, save deployment time, and save money for end-users for getting support from the internet providers.

In establishing the connection between the remote encoders and the multimedia gateway system, the remote encoders constantly send announcement to a particular multimedia gateway system. The multimedia gateway system receives the announcement from the remote encoder and records its IP address in a lookup table. Every time it receives an announcement, it compares the IP address with those recorded in the table. If the IP address is not present in the lookup table, the multimedia gateway system will update the lookup table.

In addition, once the SRT lister 301 receives an announcement from the encoder 100, it analyzes the message in the announcement including the embedded security key unique to the particular family of encoders. If the SRT listener determines that the remote encoder is suitable and safe to connect, it creates a virtual docker container that includes an SRT listener 301 and a packager 303. Docker containers can be isolated virtual instances. Each docker container is independent to ensure security. In the event that one of the docker containers is compromised, other docker containers will not be affected because there is no physical connection. The damage is thus contained in the individual virtual instance of docker containers. The multimedia gateway system may have 1 to 100 such docker containers.

The communication between the multimedia gateway system and the encoder is controlled by the encoder management 302. The encoder management controls the communication based on user preferences specified by users via, for example, the web interface. During the communication, the SRT/MGMT protocol is used to segregate internet traffic, allowing multiple simultaneous encoder/gateway system communications.

The user preferences may include without limitation resolutions, video bitrates, PIDs, GOP sizes, audio codec, audio modes, audio bitrates, DVB tables, etc. Users may enter their preferred through a web GUI hosted by an NGINX web server. The multimedia gateway system may generate a JASON file containing user settings and push to the encoders. NGINX is a web server that can also be used as a reverse proxy, load balancer, mail proxy, and HTTP cache. NGINX can be deployed to serve dynamic HTTP content on the network using FastCGI, SCGI handlers for scripts, WSGI application servers or Phusion Passenger modules, and it can serve as a software load balancer. NGINX uses an asynchronous event-driven approach, rather than threads, to handle requests. NGINX's modular event-driven architecture can provide more predictable performance under high loads.

As used herein, the term “server” refers to any computerized component, system or entity regardless of form which is adapted to provide data, files, applications, content, or other services to one or more other devices or entities on a computer network. As used herein, the term “user interface” refers to, without limitation, any visual, graphical, tactile, audible, sensory, or other means of providing information to and/or receiving information from a user or other entity, such as a GUI.

At 301, within the docker container, the SRT packets received from the remote encoder 100 are convented into MPEG-TS streaming over UDP. The outputs from the SRT listener are then sent to a packager in the docker container. At 303, the UDP-based MPEG-TS streams are packaged, for example, using Google Shaka packager (https://github.com/google/shaka-packager). In packaging the MPEG-TS streams, the packager takes the streams and creates low latency DASH video and audio segments. The segments are relatively small and may have a length of from 0.5 seconds to 2 seconds. The advantage of small segments is that it reduces the start time for the video player (e.g., a third-party player), reducing or obviating the need for buffering the segments and thus decreasing the latency. Segments are small video files, each comprising a plurality of MPEG images with small GOP sizes, e.g., less than 60 pictures in each segment. Segments can be collected and re-assembled for playout on a user device at 400. The system allows the streaming video to be played as close as to the live edge as close as to the real-time image, with reduced glass to glass latency.

Alternatively and/or additionally, packaged segments from the packager 303 are stored at web cache system 304. The web cache system 304 has two main components, a web cache module, and a prediction module. The prediction module measures the available bandwidth between clients and the multimedia gateway system and, based on the bandwidth, adjusts the encoder bitrate on the particular stream. This allows a single video profile to be used, thus increasing the user experience and limits the loss of service for the MSO.

The web cache system can also be hosted on an NGINX web server. The web server GUI allows users to change the settings for the content they want to receive. The stream contents stored in the web cache system are available for all users to download. It allows up to 400 to 1000 users to watch/download the same content simultaneously. For the users watching the same content, they can directly download the content from the web cache system instead of downloading it from the original sources. This significantly reduces latency and increases capacity of the multimedia gateway system. The streaming content can be downloaded and played by any user device 400 having an application supporting DASH, e.g., X1 App of Comcast set up box (STB), RDK.

As used herein, the term “application” or “App” refers generally to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the JavaTV™ environment.

As used herein, the terms “client device” and “end user device” include, but are not limited to, set-top boxes (e.g., DSTBs), personal computers (PCs), and minicomputers, whether desktop, laptop, or otherwise, and mobile devices such as handheld computers, PDAs, personal media devices (PMDs), such as for example an iPod™, or Motorola ROKR, and smartphones such as the Apple iPhone™

Examples of the user device 400 may include, without limitation, a computer system such as a desktop computer, notebook or laptop computer, netbook, a tablet computer, e-book reader, handheld electronic device, cellular telephone, smartphone, other suitable electronic devices, or any suitable combination thereof. As understood by one of ordinary skill in the art, any suitable communication networks, via any suitable connections, wired or wirelessly, and in any suitable communication protocols, can be used to deliver the multimedia contents. Examples of suitable communication networks include, without limitation, Local Area Networks (LAN), Wide Area Networks (WAN), telephone networks, the Internet, or any other wired or wireless communication networks.

As mentioned above, the multimedia gateway system 300, e.g., ELLVIS9000, can be controlled and managed through webgui available on port ETH1 (enp4s0) port. The internal webpage is proxied on the rest of the ports as well. For example, the multimedia gateway system can be managed by users via a user interface, accessible through all Ethernet interface. The system can be used to can convert SRT to UDP, UDP to SRT, SRT to SRT, UDP to DASH and SRT to DASH streams.

If a stream is active it will be highlighted in green color and the available controls will be: STOP, EDIT and DELETE. If the stream is just configured, but not running the options will be: PLAT, EDIT and DELETE, and the stream will be highlighted in white. When the stream in error mode it will be highlighted in red and an error message will be displayed on the top of the page.

When a stream is selected stream details and SRT statistics for it will be shown on the bottom of the page. Bandwidth and Latency charts are shown for visual aid in troubleshooting.

The multimedia gateway system supports SRT and UDP input and output stream options. The available SRT modes include: (a) Listener Mode Sets a device to wait for a request to start an SRT streaming session. The Listener device only needs to know that it should listen for an SRT stream on a certain port; (b) Rendezvous mode allows two devices behind firewalls to negotiate an SRT session over a mutually agreed upon the port. Both source and destination must be in Rendezvous mode; and (c) Caller mode sets a device to send a request to SRT listener device. The caller needs to know the Listener's IP address and listening port. The multimedia gateway system supports both Unicast and Multicast IP delivery with user-adjustable TTL. Destination IP address, port and TTL need to be set. Network interface enp6s0 is dedicated for UDP TS and it's the only one that will pass multicast data. Unicast UDP streams can be configured on both enp4s0 and enp6s0.

A Unicast transmission/stream sends IP packets to a single recipient on a network. A Multicast transmission sends IP packets to a group of hosts on a network. If the streaming video is to be distributed to a single destination, then the destination IP address and port on the ELLVIS9000 must equal to the receiving decoder IP address and port. If the application requires the decoding of the stream at multiple concurrent locations, then the destination IP address and port must be set to a valid Multicast IP address in the range of 224.0.0.0 to 239.255.255.255.

Multicasting is not supported on some legacy network devices. Before using the multimedia gateway in Multicast streaming mode, check the functional specifications of the network infrastructure to ensure that the Multicast stream will not create major traffic on the network. Verify that backbone switch supports Internet Group Messaging Protocol (IGMP) snooping, which allows the core of the network to ignore the traffic streams that Multicasting may generate.

The stream configuration page allows the user to select all input- and out-stream parameters. Protocol options are: UDP or SRT

If SRT protocol is selected the Mode setting can be used to enforce caller, listener or rendezvous mode. When it's not specified, then it is “deduced” the following way. If the port is specified, but the host IP address is empty, the multimedia gateway assumes listener mode. When both host IP address and port are specified, the system assumes caller mode. The rendezvous mode is not deduced and it has to be specified explicitly.

IP address and Port fields specify host IP address and port for input streams and destination IP address and port for output streams. The latency field is used only in SRT protocol and it sets the maximum accepted transmission latency and should by >=2.5 times the RTT. If left blank defaults to 120 ms; when both parties set different values, the maximum of the two is used for both. TTL sets time-to-live for the stream.

Drop Packets checkbox sets whether to drop packets that are not delivered on time. The default is enabled. The timeout parameter sets the timeout for any activity from any medium.

SRT streams can be encrypted using AES cryptographic algorithms and decrypted at their destination. To implement encryption on an SRT stream, the type of encryption must be specified on the source device, and then a passphrase on both source and destination. Encryption can be set to AES-128, 196 or 256 modes. Passphrase specifies a string used to generate the AES encryption key wrapper via a one-way function such that the encryption key wrapper used cannot be guessed from knowledge of the password. An encryption key is required if encryption is enabled on the SRT stream. It specifies the passphrase string used to generate the keys to protect the stream. The range is 10 to 24 characters.

Graph settings update interval specifies the time that ELLVISS captures statistics for the received SRT stream. Stream Metadata allows the user to enter a comment/name for the SRT stream.

Dash Output Settings requires segment duration, minimum update period, minimum buffer time, suggested presentation delay, time shift buffer, preserved segments outside of the live window. Segment template with constant duration is reserved for future use.

Standard values for DASH settings include: Segment size=1-5 sec; Min update period=5 sec; Min Buffer time=0 or less than segment size; Presentation delay=2*segment size; Time Shift Buffer=4*Segment size+6; Preserved Segments Outside of Live Window=Time Shift Buffer+2*segment size.

The Network Settings tab is used to set the network configuration and address for the ethernet ports. The multimedia gateway system has four 10/100/1000 RJ45 ports, enp4s0, enp6s0, enp8s0 and enp9s0. Port enp4s0 is reserved for management and internet connections, port enp6s0 is for UDP output. The enp6s0 is the only port that supports multicast traffic. Ports enp8s0 and enp9s0 are disabled and reserved for future functionality

Standard multimedia gateway system units are using port 80 for web management, custom versions with SSL certificates will use port 443 and will be accessible via secure HyperText Transfer Protocol.

An example of a multiple stream SRT media gateway, such as ELLVIS9000, is characterized by one or more the following specifications:

MANAGEMENT

1000BaseT Ethernet Interface

Web GUI

INPUT

ISO/IEC 13818 SPTS/MPTS MPEG TS, 1000BaseT

UDP/SRT Protocol, UDP, Multicast

OUTPUT

ISO/IEC 13818 SPTS/MPTS MPEG TS, 1000BaseT

UDP/SRT Protocol, UDP, Multicast, One to Many Fan Out.

Dynamic Adaptive Streaming over HTTP/HTTPS (DASH)

LATENCY

20 to 8000 ms

ENVIRONMENTAL AND POWER

Power 35 W @ 90 to 240 VAC (Internal Power)

Weight 5 lb

Operational Temp 0° to 50° C.

Storage Temp −10° to 60° C.

### Definitions

To aid in understanding the detailed description of the compositions and methods according to the disclosure, a few express definitions are provided to facilitate an unambiguous disclosure of the various aspects of the disclosure. Unless otherwise defined, all technical and scientific terms used herein have the same meaning as commonly understood by one of ordinary skill in the art to which this disclosure belongs.

It is noted here that, as used in this specification and the appended claims, the singular forms “a,” “an,” and “the” include plural reference unless the context clearly dictates otherwise.

The terms “including,” “comprising,” “containing,” or “having” and variations thereof are meant to encompass the items listed thereafter and equivalents thereof as well as additional subject matter unless otherwise noted.

The phrases “in one embodiment,” “in various embodiments,” “in some embodiments,” and the like are used repeatedly. Such phrases do not necessarily refer to the same embodiment, but they may unless the context dictates otherwise.

The terms “and/or” or “/” means any one of the items, any combination of the items, or all of the items with which this term is associated.

The word “substantially” does not exclude “completely,” e.g., a composition which is “substantially free” from Y may be completely free from Y. Where necessary, the word “substantially” may be omitted from the definition of the invention.

As used herein, the term “approximately” or “about,” as applied to one or more values of interest, refers to a value that is similar to a stated reference value. In some embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value). Unless indicated otherwise herein, the term “about” is intended to include values, e.g., weight percents, proximate to the recited range that are equivalent in terms of the functionality of the individual ingredient, the composition, or the embodiment.

As used herein, the term “each,” when used in reference to a collection of items, is intended to identify an individual item in the collection but does not necessarily refer to every item in the collection. Exceptions can occur if explicit disclosure or context clearly dictates otherwise.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All methods described herein are performed in any suitable order unless otherwise indicated herein or otherwise clearly contradicted by context. In regard to any of the methods provided, the steps of the method may occur simultaneously or sequentially. When the steps of the method occur sequentially, the steps may occur in any order, unless noted otherwise.

In cases in which a method comprises a combination of steps, each and every combination or sub-combination of the steps is encompassed within the scope of the disclosure, unless otherwise noted herein.

Each publication, patent application, patent, and other reference cited herein is incorporated by reference in its entirety to the extent that it is not inconsistent with the present disclosure. Publications disclosed herein are provided solely for their disclosure prior to the filing date of the present invention. Nothing herein is to be construed as an admission that the present invention is not entitled to antedate such publication by virtue of prior invention. Further, the dates of publication provided may be different from the actual publication dates, which may need to be independently confirmed.

It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A system for providing low latency multimedia streaming, comprising:
a video/audio encoder, wherein the encoder:
receives from a capture device a video stream comprising video/audio signals and captioning data associated with the video stream;
segments the video stream into a plurality of multimedia segments;
encodes the multimedia segments into a packetized elementary stream;
multiplexes the packetized elementary stream into a MPEG-TS stream by a transport-stream (TS) multiplexer; and
packetizes the multiplexed stream into a plurality of Secure Reliable Transport (SRT) packets and transmits the SRT packets by an SRT caller over a network; and
a multimedia gateway, wherein the multimedia gateway:
receives by an SRT listener the SRT packets transmitted from the SRT caller of the encoder after establishing a secure connection with the encoder;
restores the SRT packets to MPEG-TS streams; and
re-packages the MPEG-TS streams to dynamic adaptive streaming over HTTP (DASH) multimedia segments, allowing the DASH multimedia segments to be transmitted to a user device whereby the DASH multimedia segments are collected and reconstituted for display on the user device.

2. The system of claim 1, wherein following re-packaging the MPEG-TS streams to the DASH multimedia segments, the system further stores the DASH multimedia segments in a web cache accessible by the user device.

3. The system of claim 2, wherein the web cache is hosted on an NGINX web server.

4. The system of claim 1, wherein the encoder is an H.264/AVC encoder.

5. The system of claim 1, wherein the encoder is a single or multichannel broadcast video/audio encoder.

6. The system of claim 1, wherein the MPEG-TS stream has a Group of Pictures (GOP) size of 60 or lower.

7. The system of claim 1, wherein the MPEG-TS stream has a GOP size of 12 or lower.

8. The system of claim 1, wherein the packetized elementary stream has a 188-byte packet size.

9. The system of claim 1, wherein the SRT packets are encrypted.

10. The system of claim 9, wherein the SRT packets are encrypted by an AES 128-bit standard, an AES 196-bits, or an AES 196-bit standard.

11. The system of claim 1, wherein at least one of the MPEG-TS streams is encoded in an MPEG-2 format.

12. The system of claim 1, wherein at least one of the MPEG-TS streams is encoded by an H.264/AVC codec.

13. The system of claim 1, wherein an audio portion of at least one of the MPEG-TS streams is encoded by a Dolby codec.

14. The system of claim 1, wherein at least one of the DASH multimedia segments has a segment size between about 0.5 seconds and about 2 seconds.

15. The system of claim 1, wherein the video stream comprises a live video stream.

16. The system claim 15, wherein the video stream is obtained from the capture device in a multiple dwelling unit (MDU).

17. The system of claim 16, wherein the capture device is a surveillance camera or a CCTV camera.

18. The system of claim 1, wherein the user device is selected from the group consisting of a smartphone, a tablet computer, a laptop computer, a desktop computer, a set-top box, a television, a portable media player, a game console, a media server, a stream relay server, a server of a content distribution network (CDN), and a combination thereof.

19. The system of claim 1, wherein the system transmits the DASH multimedia segments to the user device based on an HTTP/DASH protocol.

20. The system of claim 1, wherein the network comprises one of MAN, WAN, LAN, WLANs, internet, intranet, and a combination thereof.

21. A method for providing low latency multimedia streaming, comprising:
receiving by a video/audio encoder, from a capture device, a video stream comprising video/audio signals and captioning data associated with the video stream;
segmenting the video stream into a plurality of multimedia segments;
encoding the multimedia segments into a packetized elementary stream;
multiplexing the packetized elementary stream into a MPEG-TS stream by a transport-stream (TS) multiplexer;
packetizing the multiplexed stream into a plurality of Secure Reliable Transport (SRT) packets and transmitting the SRT packets by an SRT caller over a network;
receiving by a multimedia gateway, through an SRT listener, the SRT packets transmitted from the SRT caller of the encoder after establishing a secure connection with the encoder,
restoring the SRT packets to MPEG-TS streams; and
re-packaging the MPEG-TS streams to dynamic adaptive streaming over HTTP (DASH) multimedia segments, allowing the DASH multimedia segments to be transmitted to a user device whereby the DASH multimedia segments are collected and reconstituted for display on the user device.

22. The method of claim 21, wherein further comprising, following re-packaging the MPEG-TS streams to the DASH multimedia segments, storing the DASH multimedia segments in a web cache accessible by the user device.

23. The method of claim 22, wherein the web cache is hosted on an NGINX web server.

24. The method of claim 21, wherein the encoder is an H.264/AVC encoder.

25. The method of claim 21, wherein the MPEG-TS stream has a Group of Pictures (GOP) size of 60 or lower.

26. The method of claim 21, wherein the MPEG-TS stream has a GOP size of 12 or lower.

27. The method of claim 21, wherein the SRT packets are encrypted by an AES 128-bit standard, an AES 196-bits, or an AES 196-bit standard.

28. The method of claim 21, wherein at least one of the MPEG-TS streams is encoded by an H.264/AVC codec.

29. The method of claim 21, wherein an audio portion of at least one of the MPEG-TS streams is encoded by a Dolby codec.

30. The method of claim 21, wherein at least one of the DASH multimedia segments has a segment size between about 0.5 seconds and about 2 seconds.

31. The method of claim 21, wherein the video stream comprises a live video stream.

32. The method of claim 31, wherein the video stream is obtained from the capture device in a multiple dwelling unit (MDU).

33. The method of claim 32, wherein the capture device is a surveillance camera or a CCTV camera.

34. The method of claim 21, wherein the user device is selected from the group consisting of a smartphone, a tablet computer, a laptop computer, a desktop computer, a set-top box, a television, a portable media player, a game console, a media server, a stream relay server, a server of a content distribution network (CDN), and a combination thereof.

35. The method of claim 21, further comprising transmitting the DASH multimedia segments to the user device based on an HTTP/DASH protocol.
